(19) United States
(12) Patent Application Publication
(10) Pub. No.: US 2005/0089336 A1
(43) Pub. Date: Apr. 28, 2005

(54) Metro wavelength division multiplexing network

(76) Inventors: Seong-Taek Hwang, Pyeongtaek-si (KR); Gyu-Woong Lee, Suwon-si (KR); Dong-Han Lee, Daejeon (KR); Yun-Je Oh, Yongin-si (KR)

Correspondence Address: CHA & REITER, LLC, 210 ROUTE 4 EAST STE 103, PARAMUS, NJ, 07652, US

(21) Appl. No.: 10/847,059

(22) Filed: May 17, 2004

(30) Foreign Application Priority Data
Oct. 27, 2003 (KR) 2003-75190

(51) Int. Cl. H04B 10/02

(52) U.S. Cl. 398/173

(57) ABSTRACT

A metro wavelength division multiplexing network is disclosed and includes a plurality of optical repeaters, connected through an optical-fiber link, each of the optical repeaters having a Raman-gain medium for Raman-amplifying an inputted optical signal, and a semiconductor optical amplifier for amplifying the Raman-amplified optical signal, wherein each of the optical repeaters accepts a pump light having a designated wavelength for pumping the corresponding Raman-gain medium.

### CLAIM OF PRIORITY

This application claims priority to an application entitled “METRO WAVELENGTH DIVISION MULTIPLEXING NETWORK,” filed in the Korean Intellectual Property Office on Oct. 27, 2003 and assigned Serial No. 2003-75190, the contents of which are hereby incorporated by reference.

### BACKGROUND OF THE INVENTION

1. Field of the Invention

The present invention relates to an optical communication network and, more particularly, to a metro wavelength division multiplexing (WDM) network.

2. Description of the Related Art

A metro optical communication network employs a method of alternately using an erbium-doped fiber amplifier (EDFA) and a Raman amplifier in order to amplify an attenuated optical signal for transmitting a large amount of data over a long distance.

In order to accept many channels, the optical amplifier must have a flat broad bandwidth gain. The EDFA typically employs a gain-flattening filter in order to obtain the flat gain. In contrast, the Raman amplifier couples a plurality of pump lights having different wavelengths in order to obtain the flat gain. For example, since a peak of the Raman gain of the Raman amplifier occurs at a long wavelength separated from the wavelength of the pump light by 13THz, a desired amplification bandwidth is variously selected according to the peak of the Raman gain. The Raman amplifier controls the gain flatness by employing a plurality of pump wavelengths. However, as the Raman amplifier has poor efficiency in amplification, the Raman amplifier further employs a pump light source having a high output in order to achieve the high output, thus raising the price of the amplifier.

Now that semiconductor optical amplifiers (SOA) are widely used, there have been several attempts to replace the EDFA with the SOA even though the SOA has several disadvantages. For example, the SOA has a low output and a high noise factor. However, the SOA can be mass-produced and miniaturized, thus having excellent economic efficiency.

A metro wavelength division multiplexing network having a short optical-relay period does not require a high output of the optical amplifier; thus, it is an ideal to employ the SOA. In order to solve the above-mentioned drawbacks of the SOA, such as low output and a high noise factor, a method of simultaneously using the SOA and the Raman amplifier has been proposed. This is mainly because the Raman amplifier has a low output and a low noise factor, thus overcoming the drawbacks of the SOA.

FIG. 1 is a schematic diagram showing a conventional metro wavelength division multiplexing network. As shown, the network 100 comprises the first to the third optical repeaters (ORs) 112 to 116, which are connected through an optical fiber link 160. The first to the third optical repeaters (ORs) 112 to 116 respectively include Raman-gain media (RGMs) 122 to 126; a plurality of pump light sources (LSs) 131 to 133, 134 to 136, and 137 to 139; optical couplers (CPs) 142 to 146; and semiconductor optical amplifiers (SOAs) 152 to 156.

In particular, the first optical repeater 112 includes the first Raman-gain medium 122, the first to the third pump light sources 131 to 133; the first optical coupler 142; and the first semiconductor optical amplifier 152. The second optical repeater 114 includes the second Raman-gain medium 124; the fourth to the sixth pump light sources 134 to 136; the second optical coupler 144; and the second semiconductor optical amplifier 154. The third optical repeater 116 includes the third Raman-gain medium 126; the seventh to the ninth pump light sources 137 to 139; the third optical coupler 146; and the third semiconductor optical amplifier 156. Since the first to the third optical repeaters 112 to 116 have the same structure, only the first optical repeater 112 will be described in detail, as follows.

The first to the third pump light sources 131 to 133 output pump lights λ₁ to λ₃ respectively having the first to t he third wavelengths, and the first optical coupler 142 outputs the pump lights λ₁ to λ₃, which are inputted thereto, to the first Raman-gain medium 122. The first Raman-gain medium 122 is pumped by the pump lights λ₁ to λ₃, and amplifies an inputted optical signal and then outputs the amplified optical signal. The amplified optical signal passes through the first optical coupler 142, and is inputted to the first semiconductor optical amplifier 152, and the first semiconductor optical amplifier 152 re-amplifies the inputted optical signal, and then outputs the re-amplified optical signal to an optical signal link 160.

A long-distance communication network focuses a great importance in the reliability of a network unlike a metro network or subscribers which focus on the price of the network. However, the conventional metro WDM requires flat-gain characteristics for amplifying a multi-channel optical signal, thus requiring a plurality of pump-light sources to each of the optical repeaters. Therefore, the conventional metro WDM is disadvantageous in that the production cost of the optical repeaters is high.

### SUMMARY OF THE INVENTION

Therefore, the present invention has been made in view of the above problems and provides additional advantages, by providing a metro wavelength division multiplexing network having a plurality of optical repeaters having a Raman-gain medium and a semiconductor optical amplifier that are of relatively low cost.

In one embodiment, a metro wavelength division multiplexing network includes: a plurality of optical repeaters, connected through an optical fiber link, each of the optical repeaters including a Raman-gain medium for Raman-amplifying an inputted optical signal, and a semiconductor optical amplifier for amplifying the Raman-amplified optical signal, wherein each of the optical repeaters accepts a pump light having a designated wavelength for pumping the corresponding Raman-gain medium.

### BRIEF DESCRIPTION OF THE DRAWINGS

The above features and other advantages of the present invention will be more clearly understood from the following detailed description taken in conjunction with the accompanying drawings, in which:

FIG. 1 is a schematic diagram of a conventional metro wavelength division multiplexing network;

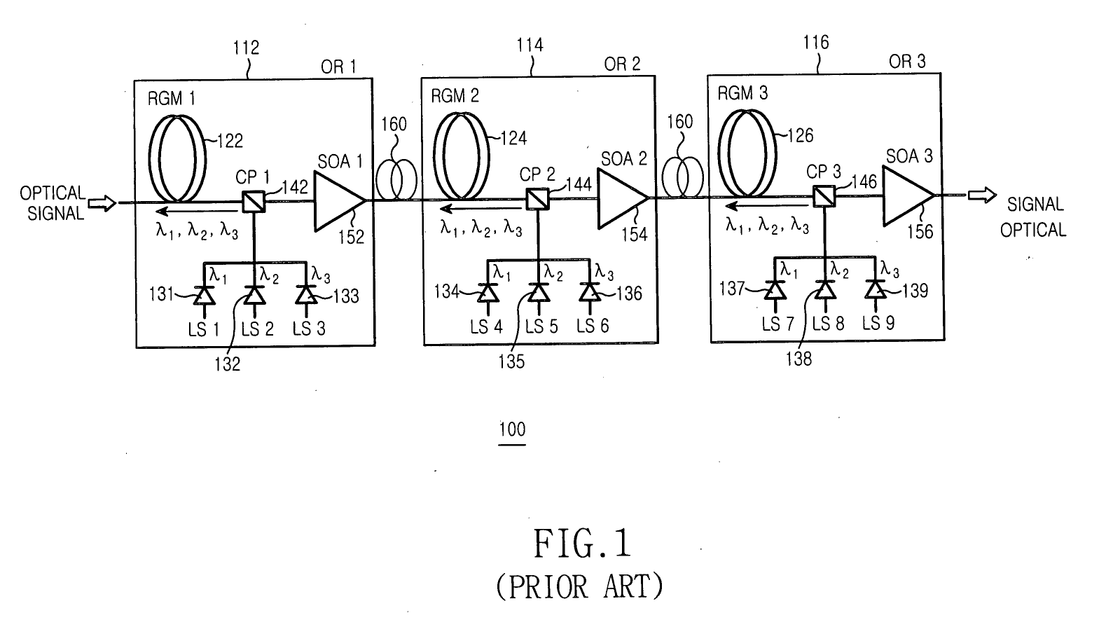

FIG. 2 is a schematic diagram of a metro wavelength division multiplexing network in accordance with a first embodiment of the present invention; and,

FIG. 3 is a schematic diagram of a metro wavelength division multiplexing network in accordance with a second embodiment of the present invention.

### DETAILED DESCRIPTION

Now, embodiments of the present invention will be described in detail with reference to the annexed drawings. In the drawings, the same or similar elements are denoted by the same reference numerals even though they are depicted in different drawings. For the purposes of clarity and simplicity, a detailed description of known functions and configurations incorporated herein will be omitted as it may make the subject matter of the present invention unclear.

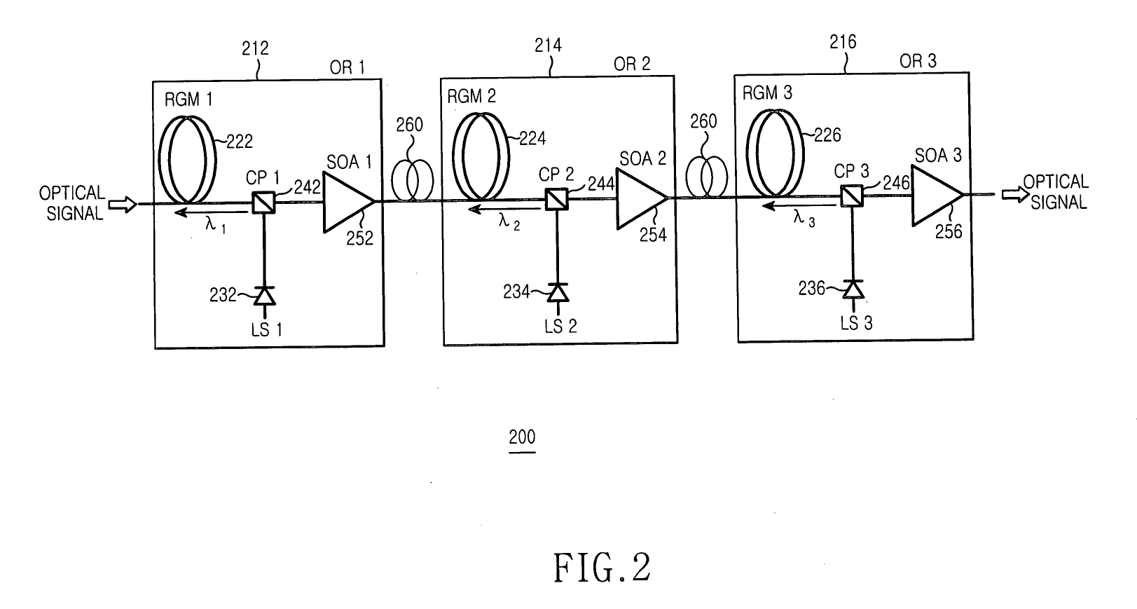

FIG. 2 is a schematic view of a metro wavelength division multiplexing network (WDM) in accordance with a first embodiment of the present invention. As shown, the network 200 includes the first to the third optical repeaters (ORs) 212 to 216, which are interconnected through an optical fiber link 260. The first to the third optical repeaters (ORs) 212 to 216 respectively include Raman-gain media (RGMs) 222 to 226, optical couplers (CPs) 242 to 246; pump light sources (LSs) 232 to 236; and semiconductor optical amplifiers (SOAs) 252 to 256. Although a limited number of repeaters is shown in FIG. 2 for illustrative purposes, it is to be understood that the metro WDM can support communications between a much larger number of repeaters. Thus, the number of repeaters in the drawing should not impose limitations on the scope of the invention.

In particular, the first optical repeater 212 includes the first Raman-gain medium 222, the first pump light source 232, the first optical coupler 242, and the first semiconductor optical amplifier 252. The second optical repeater 214 includes the second Raman-gain medium 224, the second pump light source 234, the second optical coupler 244, and the second semiconductor optical amplifier 254. The third optical repeater 216 includes the third Raman-gain medium 226, the third pump light source 236, the third optical coupler 246, and the third semiconductor optical amplifier 256.

In the embodiment, single-mode fibers, non-zero dispersion shift fibers (NZDSFs), or dispersion compensation fibers (DCFs) may be used as the first to the third Raman-gain media 222 to 226. Laser diodes may be used as the first to the third pump light sources 232 to 236. An arrayed waveguide grating (AWG), such as wavelength division multiplexing (WDM) couplers, may be used as the first to the third optical couplers 242 to 246. Typical semiconductor optical amplifiers or gain-clamped SOAs (GCSOAs) may be used as the first to the third semiconductor optical amplifiers 252 to 256.

In operation, the first pump light source 232 outputs a pump light having a first wavelength (λ₁; hereinafter, referred to as “first pump light”), and the first pump light (λ₁) is outputted to the first Raman-gain medium 222 by the first optical coupler 242. The first Raman-gain medium 222 is pumped by the first pump light (λ₁) and amplifies an inputted optical signal, then outputs the amplified optical signal. The amplified optical signal passes through the first optical coupler 242 and is inputted to the first semiconductor optical amplifier 252. The first semiconductor optical amplifier 252 further amplifies the above amplified optical signal, and then outputs the re-amplified optical signal to the optical fiber link 260.

The second pump light source 234 outputs a pump light having a second wavelength (λ₂; hereinafter, referred to as “second pump light”), and the second pump light (λ₂) is outputted to the second Raman-gain medium 224 by the second optical coupler 244. The second Raman-gain medium 224 is pumped by the second pump light (λ₂) and amplifies an inputted optical signal, then outputs the amplified optical signal. The amplified optical signal passes through the second optical coupler 244 and is inputted to the second semiconductor optical amplifier 254, and the second semiconductor optical amplifier 254 re-amplifies the above amplified optical signal, and then outputs the re-amplified optical signal to the optical fiber link 260.

The third pump light source 236 outputs pump light having a third wavelength (λ₃; hereinafter, referred to as “third pump light”), and the third pump light (λ₃) is outputted to the third Raman-gain medium 226 by the third optical coupler 246. The third Raman-gain medium 226 is pumped by the third pump light (λ₃) and amplifies an inputted optical signal, then outputs the amplified optical signal. The above amplified optical signal passes through the third optical coupler 246 and is inputted to the third semiconductor optical amplifier 256, and the third semiconductor optical amplifier 256 re-amplifies the above amplified optical signal, and then outputs the re-amplified optical signal to the optical fiber link 260.

The above optical signal includes a plurality of channels and has a designated wavelength bandwidth. Wavelengths of the first to the third pump lights (λ₁ to λ₃) are selectively designated so that a curve showing the total gain of the first to the third Raman gain media 222 to 226 is flattened according to the wavelength bandwidths of the optical signal. For example, in the first embodiment, the first wavelength is the shortest wavelength, and the third wavelength is the longest wavelength. A Raman-gain peak of each of the first to the third Raman gain media 222 to 226 is generated at a long wavelength, separated from the wavelength of the one corresponding with the first to the third pump lights (λ₁ to λ₃) by a distance of 13 THz. As a result, the channel of the optical signal amplified by the first to the third Raman gain media 222 to 226 corresponding to the gain peak has a gain higher than those of other channels which is a characteristic of Raman gain.

However, since the optical signal is amplified by the first and the third semiconductor optical amplifiers 252 to 256, differences in gain between the channels of the optical signal are reduced. Particularly, in case that the first to the third semiconductor optical amplifiers 252 to 256 are operated at a saturation area or gain-clamped semiconductor optical amplifiers are used as the first to the third semiconductor optical amplifiers 252 to 256, differences in gain between the channels of the optical signal are reduced further. The channel corresponding to the gain peak of each of the first to the third Raman-gain media 222 to 226 has an optical signal-to-noise ratio (OSNR) superior to those of other channels which is a characteristic of Raman gain. However, since the curve showing total gain of the first to the third Raman-gain media 222 to 226 is flattened according to the wavelength bandwidths of the optical signal, OSNRs of channels of the optical signal outputted from the network 200 are uniformly maintained. For example, when the pump wavelength λ₁ at repeater 1 is 1459\0 nm, the signal gain peak wavelength is 1550 nm, and 1545 nm and 1555 nm gains are lower than the gain of 1550 nm. When the pump wavelength λ₃ at repeater 3 is 1455 nm, the signal gain peak wavelength is 1555 nm, and 1550 nm and 1560 nm gains are lower than the gain of 155 nm. Therefore, the range of flat gain is from 1550 nm to 1555 nm as a result of these combination of gains.

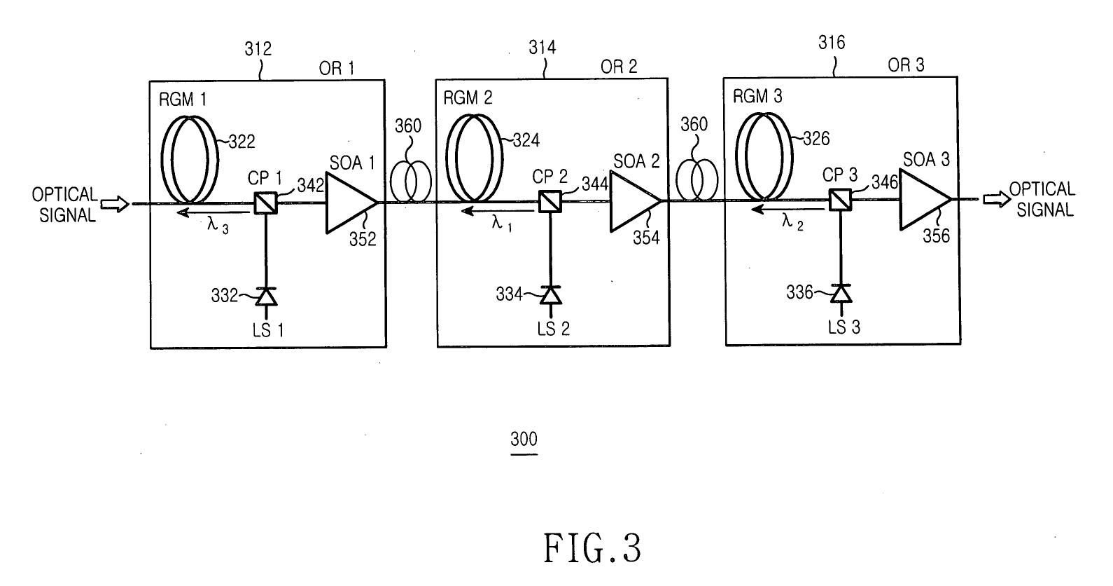

FIG. 3 is a schematic view of a metro wavelength division multiplexing network in accordance with a second preferred embodiment of the present invention. A shown, the network 300 comprises the first to the third optical repeaters (ORs) 312 to 316, which are connected through an optical fiber link 360. The first to the third optical repeaters (ORs) 312 to 316 respectively include Raman-gain media (RGMs) 322 to 326, optical couplers (CPs) 342 to 346; pump light sources (LSs) 332 to 336; and semiconductor optical amplifiers (SOAs) 352 to 356.

In particular, the first optical repeater 312 includes the first Raman-gain medium 322; the first pump light source 332; the first optical coupler 342; and the first semiconductor optical amplifier 352. The second optical repeater 314 includes the second Raman-gain medium 324; the second pump light source 334; the second optical coupler 344; and the second semiconductor optical amplifier 354. The third optical repeater 316 includes the third Raman-gain medium 326, the third pump light source 336, the third optical coupler 346, and the third semiconductor optical amplifier 356.

Note that the network 300 has the same constitution as that of the network 200 shown in FIG. 2, but differs from the network 200 in terms of a wavelength arrangement order. Thus, a detailed description of elements of the network 300 that is the same as those of the network 200 will be omitted to avoid redundancy. In the second embodiment, a first pump light source 332 outputs the third pump light (λ₃) having a third wavelength, which is the longest wavelength, and a second pump light source 334 outputs the first pump light (λ₁) having a first wavelength, which is the shortest wavelength. That is, the wavelength arrangement order can be variously changed.

As apparent from the above description, the present invention provides a metro wavelength division multiplexing network comprising a plurality of optical repeaters, in which each of the optical repeaters includes a Raman-gain medium and a semiconductor optical amplifier, and accepts a pump light having a designated wavelength for pumping one corresponding with the Raman-gain media. This inventive configuration reduces the number of pump light sources required as in the prior art, thus lowering the production cost.

Although above embodiment of the present invention has been described in detail, those skilled in the art will appreciate that various modifications, additions, and substitutions of the specific elements are possible, without departing from the scope and spirit of the invention as disclosed in the accompanying claims.

1. A metro wavelength division multiplexing network comprising:
a plurality of optical repeaters, connected through an optical fiber link, each of the optical repeaters including a Raman-gain medium for Raman-amplifying an inputted optical signal, and a semiconductor optical amplifier for amplifying the Raman-amplified optical signal,
wherein each of the optical repeaters accepts a pump light having a predetermined wavelength for pumping the corresponding Raman-gain medium.

2. The metro wavelength division multiplexing network as set forth in claim 1, wherein the semiconductor optical amplifiers include gain-clamped semiconductor optical amplifiers.

3. The metro wavelength division multiplexing network as set forth in claim 1, wherein the Raman-gain medium includes at least one selected from the group consisting of a single mode optical fiber, a non-zero dispersion shift fiber (NZDSF), or a dispersion compensation fiber (DCF).

4. The metro wavelength division multiplexing network as set forth in claim 1, wherein each of the optical repeaters further includes a pump light source for pumping the corresponding Raman-gain medium using the predetermined wavelength.

5. The metro wavelength division multiplexing network as set forth in claim 1, wherein the pump light source comprises a laser diode.

6. The metro wavelength division multiplexing network as set forth in claim 1, wherein the semiconductor amplifier comprises a gain-clamped semiconductor amplifier.

7. The metro wavelength division multiplexing network as set forth in claim 1, wherein the predetermined wavelength is selectively assigned to each of the optical repeaters so that a total gain of the plurality of Raman gain medium is flattened.

8. The metro wavelength division multiplexing network as set forth in claim 1,wherein the predetermined wavelength is assigned to each of the optical repeaters in ascending order from a shortest wavelength to a longest wavelength.
